(19) United States
(12) Patent Application Publication
(10) Pub. No.: US 2013/0282686 A1
(43) Pub. Date: Oct. 24, 2013

(54) METHODS, SYSTEMS AND COMPUTER PROGRAM PRODUCT FOR DYNAMIC CONTENT SEARCH ON MOBILE INTERNET DEVICES

(71) Applicant: Prium Inc., (US)

(72) Inventor: Umesh J. AMIN, Redmond, WA (US)

(21) Appl. No.: 13/865,192

(22) Filed: Apr. 18, 2013

Related U.S. Application Data
(60) Provisional application No. 61/636,692, filed on Apr. 22, 2012.

(51) Int. Cl. G06F 17/30

(52) U.S. Cl. CPC G06F 17/30864
USPC 707/706

(57) ABSTRACT

Disclosed are methods, system and computer program products for executing dynamic content search on a first mobile Internet device. The method comprises the steps of: enabling a content selection for search within any open application as displayed on a display screen of the first mobile Internet device; forming a search query from the selected content; submitting the search query to at least a search engine to perform the search; receiving a set of results of the search after executing the search on the search engine for the search query; and displaying the set of results on the display screen of the first mobile Internet device.

### CROSS-REFERENCE TO RELATED APPLICATION

This non-provisional patent application claims priority from the U.S. provisional patent application Ser. No. 61/636,692 filed on Apr. 22, 2012, the content of which is incorporated herein by reference.

### FIELD OF THE INVENTION

The present invention relates generally to content search, and more specifically, to methods and systems for dynamic content search on mobile Internet devices in a convenient, cost effective, secure, and user friendly manner.

### BACKGROUND OF THE INVENTION

Mobile Internet devices such as mobile phones, ipad, iphone, tablets, PDAs, electronic devices, smartphones, personal entertainment systems of automobiles, mobile devices, mobile communication devices, etc., are becoming increasingly popular and the features associated with these communication devices have become increasingly diverse. To name a few features, many mobile communication devices include cameras and numerous capabilities, for example, text messaging, email, web-browsing, Internet access, video playback and editing, audio playback, image display and editing, hands-free headset interfaces, etc. It would not be an exaggeration to say that these mobile communication devices are mobile personal computers as different applications, for example, the applications like word processor, notepad, excel sheet, social networking, location updates, power point presentation etc., which were earlier only available on personal computers are now being made available for these mobile communication devices.

Some of these mobile communication devices may include Internet browsing functionality to access Internet on such devices. A user can send emails, read an excel sheet, access the Internet, update social media, write in a word file, make a presentation, form a pie chart etc., on such mobile communication devices. The user can also use the Internet to download the documents from the Internet and read, save, edit and upload them on a server or send them as email attachments. The mobile communication devices, for example, the Blackberry mobile phone, allows users to receive emails on their mobile devices as soon as they are received on the email client. This has led to increase in the out of office work culture which allows one to be connected with colleagues and clients without being present at the office.

While browsing the Internet on the mobile communication devices, the Internet search function is one of the most commonly used features. Most of the mobile communication devices (mobile phone, tablet, smart phone, notepad, . . . ) have a dedicated Internet search function or a soft key that is used to search on the World Wide Web (WWW) based on a text query entered in the search function for information or to locate services that are local to them.

Google, Bing, Yahoo etc., are among popular search engines used by a user to perform a search for any information needed, by typing a query in the user interface of these search engines. Due to the developments in mobile device technology, like 2G, 3G, 4G, LTE, and its increase in popularity, large numbers of people have recently started to use smart phones, or the other mobile communications devices to search for information or for people, for example, one may search for the closest restaurant, or for a location of an ATM machine, or for some other provider of a service or goods. Accordingly, presently the only practical way to utilize mobile communication devices (digital appliances) for searching is through the Internet, such as by using a World Wide Web browser in a mobile communication device, with the expectation that at least some of the local services have WWW pages with contact information. However, people still use desktop computers, laptops to search or browse for almost everything from the World Wide Web. Due to a mobile device's small screen and small keypad, people usually only search from the mobile device when they really need the information right away and they don't have access to a PC.

When a user needs to search or query information from a PC or laptop computer, usually he or she opens an Internet search engine in an Internet browser and types the primary key words. For example if he needs to find restaurants in Los Angeles he will type, “restaurant in Los Angeles” and triggers the search by pressing the ‘Enter’ key on the keyboard or ‘submit’ button of the search engine user interface. The search engine executes the search using the keywords and returns a list of results. The user then reads a few results and if he is able to find the information what he is looking for, stops the search. However if he wants to narrow the search results, he needs to search within the list of results, by adding another keyword to the original keywords. For example, he needs to find restaurants in Los Angeles which serve ‘that food’, he can add ‘that food’ to the first keyword and get a narrowed result list. The user needs to do this until he gets satisfying search results.

In another example, if a user desires to perform a search while working within an application such as a word processor, the user needs to first minimize the word processor and open an Internet browser. Once the Internet browser is opened, the user then opens a search engine of his choice and inputs the search terms into the selected search engine. The search engine executes the search with the search query and returns the search results to the user. The user can extract the information returned in the search result and input that information into any application. A conventional method of conducting an Internet search on mobile device is illustrated in FIG. 1.

On a desktop/laptop computer if a user is using an application like word processor and while reading he or she encounters a term whose meaning they want to know, they can select the word and copy it by pressing Ctrl+C or right clicking and selecting the copy command from the dropdown context menu. This copied word can be pasted in the search engine input form and the word can be searched and the relevant information can be obtained as results. If a user has to do this for a number of times, this can become a tedious and very unproductive process as the user spends time going between an application and a browser in order to perform various searches. In addition, the user needs to perform the additional step of visiting the particular web site which is returned in the search results. This additional step extends the process of searching the Internet for information.

In a small screen device like a mobile Internet device, this kind of search will cause many back and forth interactions in search engine hosts, and force a user to type more stuff on their small devices. That is why most people don't prefer to perform an Internet search on a small mobile communication device like a cell phone or blackberry.

On the conventional mobile devices available, the user has to activate the internet search function first and when this function is activated, a search term is entered via keypad or voice. The internet search engine returns the results. If the text in the search results have an embedded URL, a user can click on the linked text or objects and receive more information. Majority of the mobile devices are pre-registered for the internet search engines (For example Bing, Google, or Yahoo). The current state of the art is limited to launching Internet search functionality to pre-programmed search browsers or opening an Internet browser, going to a different search engine, and entering the search terms to use a different search engine.

The existing Internet search functionalities do not link the content displayed on the mobile device screen directly to the Internet search function. While all these available mechanisms allow users to launch an Internet search engine for Internet search, none of these mechanisms allow dynamic launch of an Internet search function directly from the selected content on the screen of the mobile device.

In some web browsers like Google Chrome, there is a right-click search functionality according to which a user while reading a webpage, can select a word by highlighting it and then right clicking to get a dropdown menu which provides an option for searching that selected word or sentence in Google search engine. The function runs the search using the selected word on Google and presents the results in a new tab of the Chrome browser. This functionality may save user's time and effort of selecting the word, then copying the word by Ctrl+C or right click, then opening the search engine in a browser window, then pasting the word and then clicking the submit button or pressing the Enter key to execute the search, however, as Google Chrome's right-click search function is confined to the Google search engine which is limited to text search queries. Further, the Google Chrome or the Google search engine fail to enable the search from any open application, allowing user choice of search engine or simultaneous search over multiple search engines, expanding search input from words to various media forms, and broadening the scope of the search from the internet to the device's content or other connected mobile devices' content. Further Google Chrome's right-click search functionality fail to takes the right-click search function from the PC to various other mobile platforms with a single click selection for search and flexibility of results display.

While in the personal computer environment where multiple screens and user input options are available, it is easy to cut, copy, and paste text into the input field of a search engine to efficiently perform the search. In the mobile communications device environment, such options are not readily available. A user has to remember the exact phrase or go through a more difficult copy and paste process and open the search browser and type in the text or phrase to get the Internet search results. Some mobile Internet search functions provide recommendation words or terms as the user begins entering the search terms to minimize the keystrokes. Also, when it comes to PC there are many find and search functions available to search text based content in the PC; however, when it comes to mobile devices, this basic search and find function of PCs is virtually no-existing in most of the mobile communications devices.

Accordingly, there exists a need for improved means to dynamically launch an Internet search function or the mobile device content search function directly from the selected screen content on a mobile device such that the user has to take fewer steps to select the search term, and perform the better search in a prompt, convenient, and user-friendly manner.

### SUMMARY OF THE INVENTION

In view of the foregoing shortcomings inherent in the search function on the mobile Internet devices of today, the general purpose of the present invention is to provide an improved combination of convenience and utility, to include the advantages of the prior art, and to overcome the drawbacks inherent therein.

In one aspect, the present invention provides a method for executing dynamic content search on a first mobile Internet device. The method comprises the steps of: enabling a content selection for search within any open application as displayed on a display screen of the first mobile Internet device; forming a search query from the selected content; submitting the search query to at least a search engine to perform the search; receiving a set of results of the search after executing the search on the search engine for the search query; and displaying the set of results on the display screen of the first mobile Internet device.

In another aspect, the present invention provides a method for executing a dynamic search on at least content of a connected mobile device. The method comprises the steps of: enabling a content selection within any open application as displayed on a display screen of the first mobile Internet device; forming a search query from the selected content; submitting the search query to a search engine of a second mobile Internet device to perform the content search; returning at least a search result after executing the search on the content of the second mobile Internet device and program code for displaying the set of results on the display screen of the first mobile Internet device.

In yet another aspect, the present invention provides a system for dynamic Internet search on a mobile Internet device. The system comprises: a content selecting module configured for selecting a content within any open application as displayed on a display screen of the mobile Internet device; a search query formation module configured to form a search query from the selected content; a search query submission module configured for submitting the search query to an Internet search engine; and a data communications module configured to communicate the data related to the search query, wherein a search engine selection module is adapted to select at least one of the Internet search engine and mobile device search engine.

It is further an aspect of the present invention to provide, a computer program product having computer executable instructions stored in a computer readable medium for directing a computer embodied in a first mobile Internet device. The computer program product comprising at least a program code for executing at least one of the steps of: enabling a content selection within any open application as displayed on a display screen of the first mobile Internet device; forming a search query from the selected content; submitting the search query to a search engine to perform the search; returning at least a search result after executing the search on the search engine for the search query; and displaying the search result on the display screen of the first mobile Internet device.

In yet another aspect, the present invention provides a computer program product comprising computer executable instructions stored in a computer readable medium for directing a computer embodied in a first mobile Internet device for executing dynamic search on the content of the first mobile Internet device. The computer program product comprising at least a program code for executing at least one of the steps of: enabling the selection of a content within any open application as displayed on a display screen of the first mobile Internet device; forming a search query from the selected content; submitting the search query to a search engine of the first mobile Internet device to perform the content search; returning at least a search result after executing the search on the content of the first mobile Internet device; and displaying the search result on the display screen of the first mobile Internet device.

In another aspect, the present invention provides a computer program product comprising computer executable instructions stored in a computer readable medium for directing a computer embodied in a first mobile Internet device for executing dynamic search on at least a content of a second mobile Internet device. The computer program product comprising at least a program code for executing at least one of the steps of: enabling a content selection within any open application as displayed on a display screen of the first mobile Internet device; forming a search query from the selected content; submitting the search query to a search engine of the second mobile Internet device to perform the content search; and returning at least search result after executing the search on the content of the second mobile Internet device and program code for displaying the set of results on the display screen of the first mobile Internet device

These together with other objects of the invention, along with the various features of novelty that characterize the invention, are pointed out with particularity in the claims annexed hereto and forming a part of this disclosure. For a better understanding of the invention, its operating advantages and the specific objects attained by its uses, reference should be made to the accompanying drawings and descriptive matter in which there are illustrated exemplary embodiments of the present invention.

### BRIEF DESCRIPTION OF THE DRAWINGS

While the specification concludes with claims that particularly point out and distinctly claim the invention, it is believed the expressly disclosed exemplary embodiments of the present invention can be understood from the following description taken in conjunction with the accompanying drawings, in which like reference numerals identify the same elements. The drawings and detailed description which follow are intended to be merely illustrative of the expressly disclosed exemplary embodiments and are not intended to limit the scope of the invention as set forth in the appended claims. In the drawings:

FIG. 1 illustrates a conventional method of conducting an Internet search on a mobile Internet device;

FIG. 2 illustrates a schematic diagram of an exemplary system for dynamic content search on mobile Internet devices, according to an exemplary embodiment of the present invention;

FIG. 3 illustrates an exemplary architecture of the mobile Internet device;

FIG. 4 illustrates a flowchart of a method for dynamic content search on mobile Internet devices, according to an exemplary embodiment of the present invention;

FIG. 5 illustrates a flowchart of a method for executing a dynamic search on content of a second mobile Internet device, according to an exemplary embodiment of the present invention;

FIG. 6 illustrates a schematic diagram of a system for dynamic content search on a mobile phone, according to one embodiment of the present invention.

Like reference numerals refer to like parts throughout the several views of the drawings.

### DETAILED DESCRIPTION OF THE DRAWINGS

The exemplary embodiments described herein detail for illustrative purposes are subject to many variations and designs. It should be emphasized, however that the present invention is not limited to particular method and system of search functionality in the mobile communication devices as shown and described. Rather, the principles of the present invention can be used with a variety of mobile communication device or mobile phone search methods and techniques. It is understood that various omissions, substitutions of equivalents are contemplated as circumstances may suggest or render expedient, but the present invention is intended to cover the application or implementation without departing from the spirit or scope of the its claims.

In the following description, for purposes of explanation, numerous specific details are set forth in order to provide a thorough understanding of the present invention. It will be apparent, however, to one skilled in the art that the present invention may be practiced without these specific details.

The use of terms ‘including’, ‘comprising’, or ‘having’ and variations thereof herein are meant to encompass the items listed thereafter and equivalents thereof as well as additional items. Further, the term ‘plurality’ refers to the presence of more than one of the referenced item and the terms ‘a’, ‘an’, and ‘at least’ do not denote a limitation of quantity, but rather denote the presence of at least one of the referenced item. The term ‘device’ also includes ‘engine’ or ‘machine’ or ‘system’ or ‘apparatus’ or ‘appliance’.

The terms ‘communication device’ or ‘mobile phone’ or ‘mobile device’ or ‘mobile communication device’ or ‘mobile electronic device’ or ‘mobile Internet device’ may be used herein interchangeably and refer to and convey the same meaning.

Although the exemplary embodiments herein will be described with reference to the mobile phone for exemplary purposes only, it should be understood that the embodiments could be applied equally to any suitable device incorporating, a display, processor, memory and supporting software or hardware for implementing aspects of the disclosed embodiments. The mobile phone refers to different electronic devices such as cell phones working on LTE, UMTS, CDMA 1X RTT, or GSM/EDGE or WiFi technology, Blackberry, iphone, iPad, itab, smartphones, personal digital assistants (PDA), tablet PCs, mobile Internet appliance, personal entertainment systems of automobiles, and similar computing or communication devices.

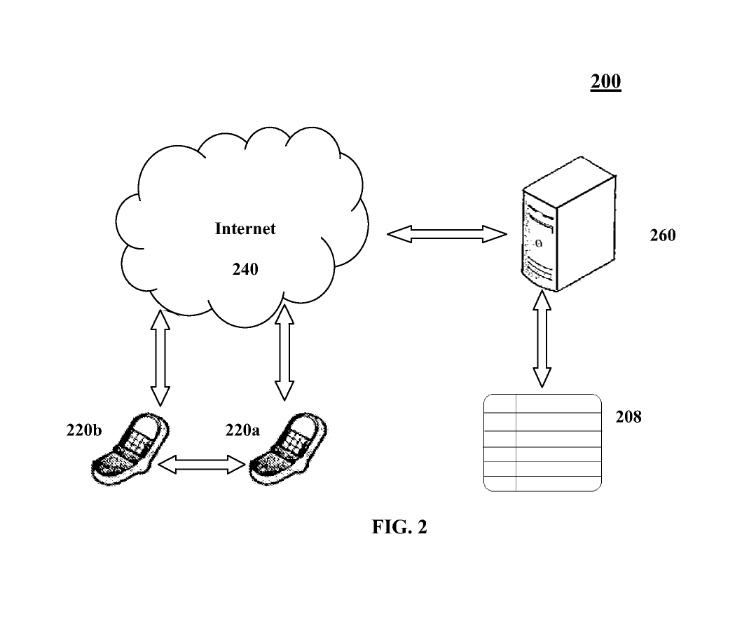

Referring to FIG. 2, which illustrates a schematic diagram of an exemplary system 200 for dynamic content search on mobile Internet devices, according to an exemplary embodiment of the present invention. The system 200 comprise: at least a communication device, for example, a first mobile Internet device 220a; Internet 240; at least a search engine 260 (also referred to as ‘search server’ or ‘Internet search engine’); and at least a search database 280. To perform a search on the first mobile Internet device 220a, a user needs to connect to the Internet 240 and open an Internet search engine 260 using an Internet browser application. A browser based implementation allows the system 200 features to be accessible regardless of the platform of the first mobile Internet device 220a. The operating system of at least one of the mobile Internet device 220a and 220b may be Android, Symbian, Windows, or any operating systems capable of being used for mobile Internet devices. In another case at least one of the first mobile Internet device 220a and a second mobile Internet device 220b may directly connect to the search engine 260 without the need of a browser application. The user can enter his search query by typing it in the search form of the search engine 260 and submit it to the search engine 260. The mobile Internet device 220a and 220b communicates to the Internet 240 by using its communication network. The search engine 260 searches the search query in the search database 280 and returns the set of results to the mobile Internet device 220a via the Internet 240.

In an exemplary embodiment, the present invention also provides mobile to mobile search functionality, for example, content search between two mobile Internet devices, i.e. the first mobile Internet device 220a and a second mobile Internet device 220b (as shown in FIG. 2). The first mobile Internet device 220a and the second mobile Internet device 220b are communicably connected with each other. The second mobile Internet device 220b may include a device that is on a public Wide Area Network (wired or wireline) or on a Local Area Network (wired or wireless) or on a Personal Area Network (PAN) connection and is accessible to other mobile internet devices, for example the first mobile Internet device 220a.

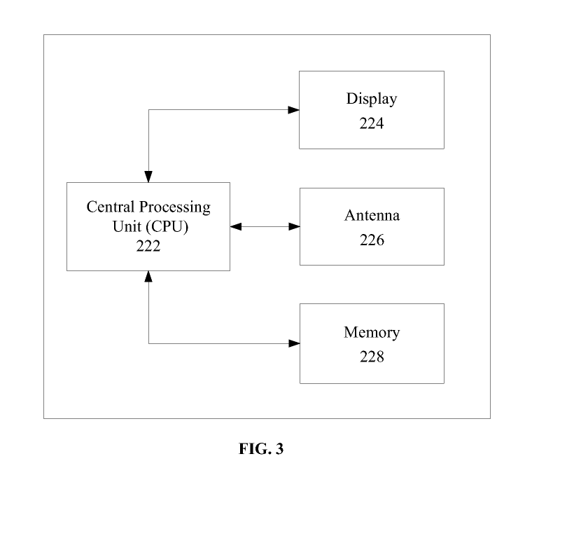

Referring to FIG. 3, which illustrates a schematic drawing showing the architecture of the first mobile Internet device 220a. The first mobile Internet device 220a has an antenna 226, a display or display screen 224, a keypad (not shown) for entering an input, a central processing unit (CPU) 222, a memory 228 and other phone components (not shown). The antenna 226 allows the first mobile Internet device 220a to send and receive signals from a network such as carrier network or a local area network. The display 224 is used to display the contents of the first mobile Internet device 220a. The display 224 may include any suitable information such as for example, a service signal strength indicator, a battery indicator, the active ringing or alert mode for incoming calls or messages, the time and soft key functions. The display 224 may be a touch screen display such that the keypad and other commands can be triggered by touching the display screen. The display 224 may also include any suitable menu such as, for example, a power button menu which may have suitable options that allow a user to turn off the first mobile Internet device 220a, lock the keypad of the first mobile Internet device 220a, set the ringing style etc. The menu may also include an option for activating the search.

The first mobile Internet device 220a may be connected to a mobile telecommunications network through radio frequency (RF) links via base stations. The mobile telecommunications network may be in compliance with any commercially available mobile telecommunications standard such as LTE, GSM/EDGE, UMTS, CDMA2000, FOMA and TD-SCDMA or a WiFi standard. The mobile telecommunications network may be operatively connected to a wide area network or a pico cell, or a private base station or a WiFi router, which may be the Internet connectivity or a part thereof. An Internet server has data storage and is connected to the wide area network, as is an internet client computer. The server may host a worldwide web (WWW) server capable of serving www content to the first mobile Internet device 220a.

The memory 228 is provided to store data and applications associated with the first mobile Internet device 220a. The memory 228 may be a RAM, ROM in the form of a SD card or any hardware which allows storing data on the first mobile Internet device 220a. The CPU 222 is the processor which controls the operation of the first mobile Internet device 220a and may have an integrated muti-core digital signal processor(s). The first mobile Internet device 220a has a media processor to manage all media processing in the device and a baseband processor that processes the communication with a cellular network or local area network via a transmitter/receiver circuit and the antenna 226. The CPU 222 interacts with all components of the first mobile Internet device 220a and processes the data and signals to produce the desired output. The CPU 222 is connected to the display 224 for processing user inputs and displaying information on the display 224. The first mobile Internet device 220a also includes some other components like microphone, speakers, keypad etc which are standard components used in the first mobile Internet device 220a and are known in the prior art.

The first mobile Internet device 220a may also be capable of communicating locally via a local link to one or more local devices. The local link may be any suitable type of link with a limited range, such as Bluetooth, a Universal Serial Bus (USB) link, a wireless Universal Serial Bus (WUSB) link, an IEEE 802.11 wireless local area network (WLAN) link, an RS-232 serial link, etc. The local devices can, for example, be various sensors that can communicate with the first mobile Internet device 220a over the local link. The above examples are not intended to be limiting, and any suitable type of link may be utilized. The local devices may be antennas and supporting equipment forming a WLAN implementing Worldwide Interoperability for Microwave Access (WiMAX, IEEE 802.16), WiFi (IEEE 802.11x) or other communication protocols. The WLAN may be connected to the Internet 240. The first mobile Internet device 220a may thus have multi-radio capability for connecting wirelessly using mobile communications network, WLAN or both. Communication with the mobile telecommunications network may also be implemented using WiFi, WiMax, or any other suitable protocols, and such communication may utilize unlicensed portions of the radio spectrum.

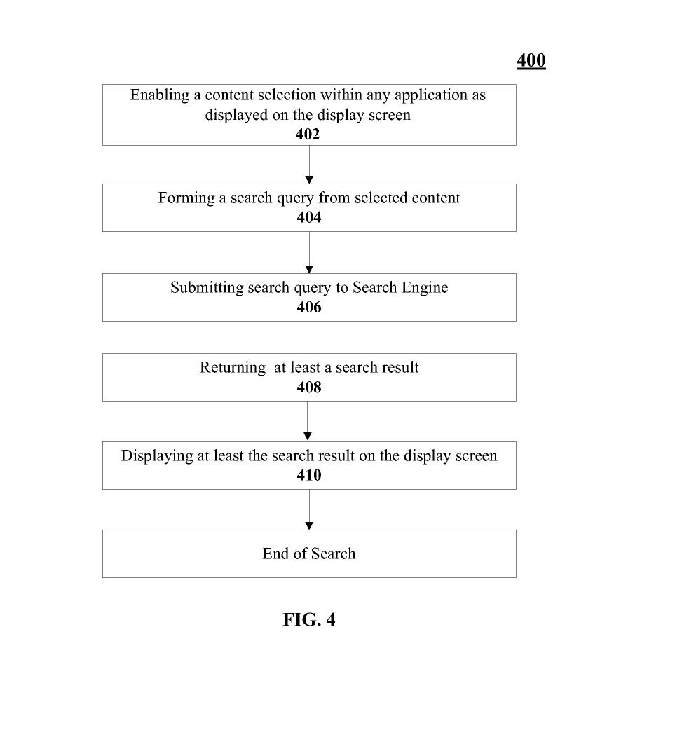

Referring to FIG. 4, which illustrates a flowchart of a method 400 for dynamic content search on mobile Internet devices, according to one embodiment of the present invention. The method 400 starts with a step 402 of enabling a content selection within any open application as displayed on the display 224 of the first mobile Internet device 220a. When a user is working with a first mobile phone application, for example a word processor on the display 224 of the first mobile Internet device 220a and while the user is using the application, the user needs to conduct a search for a word in the application, wherein the user can select that word in the first step. In another example if the user has SMS application opened and he needs to search for a word in the text of the SMS, the user can select the word. The selection of the content may be done by standard method used in existing prior art like highlighting, clicking, etc.

In one embodiment the content can be a word, a phrase, or an image or an object on the display 224 of the first mobile Internet device 220a. For example if the user is reading a webpage, or a document, or an SMS, or reviewing a photo, or has paused a video on the display 224, a word or a phrase or a text or an image or an object from the display 224 can be selected to form a search query. The content may also be an image for example if person visits a place say ‘Taj Mahal’ and needs to know more information about it, he can click a photo of Taj mahal and use the image as a search query to perform the search. In one embodiment the search query may further include text along with the image for better search results. The search will return results related to the image of the ‘Taj Mahal’ and information available with it. The image search may need special type of search engines to perform the image search.

Methods by which a content may be selected, include using a click on the word or the phrase or the text or the image or the object on a touch screen first mobile Internet device 220a, clicking a button or other method available on the device to select the search input. The present invention is not limited to text but may also be used in conjunction with scanned data, text recognition devices and files, image files, MPEG files, voice commands and other user input and available data. Also an audio input may be used to select the text or display on the screen 224.

At a step 404 of the method 400, a search query is formed from the selected content. The selected content which may be text or image or video file displayed currently on the display screen is used to form the search query. For example in the SMS application a user encounters a message saying ‘call me at 8:00 P. M in IST’, and the user needs to know what that time is in his time zone. He can highlight the text ‘IST’ and form a search query.

At a step 406 of the method 400, the search query is submitted to the search engine 260 to perform the search. The search engine 260 is communicably connected with the Internet 240. The search may be done in many ways including but not limiting to providing a drop down menu to a user to select the search engine, a right click of a mouse, a keyboard command, or a voice command or other method causing the Internet search engine 260 to initiate the search without having the user to select a search engine. This may also be done by providing a link that may be activated or clicked on by the user. The created link may contain the search terms selected by a user. When the link is clicked a search is performed using the terms in the link. In another embodiment the search option may be incorporated as one of the soft key functions in standby mode.

According to an exemplary embodiment of the present invention, the user is given a choice to select the search engine 260 where he wants to perform the search. He can chose a search engine like Google, Bing, Yahoo, AltaVista or any such search engine available. The search is executed on the search engine 260 of the user's choice. In another embodiment the user can also chose to run the search query in multiple search engines simultaneously and get the results from all chosen search engines. For example he can choose to run his search query on Google and Yahoo and get the results from both of them. In another embodiment the user can also chose to run the search query on a meta search engine which gives results from multiple search engines.

According to another exemplary embodiment of the present invention, the surrounding text or data of the selected content may be used as context to refine the search results. The word selected may have different meaning in the context of the sentence where it is used. It is additional functionality to enable the use of surrounding text or data to understand the context where the selected word is used and form the search query. The search query thus formed may also contain few words from the surrounding text of the selected text.

The search is typically performed as indicated by the configuration settings defined by the user. The search may be performed through the search engine 260 or over the Internet or through various other types of databases or networks or the content stored in the device, including but not limited to, intranets and extranets. The user may choose which search engine (e.g. Google, Yahoo, Bing etc) or any other specified website is to be used for the search. Alternatively, a user may choose that the search be performed on more than one search engine. In one embodiment the search function may allow a user to search any suitable medium such as for example, the memory or the content of the first mobile Internet device 220a or the Internet 240 (World Wide Web). A user may also employ the search function to search for suitable information stored in the first mobile Internet device 220a such as, for example, phone book entries, calendar entries, images, videos, music, or other words documents or emails or attachments etc, and the like. The search function may also allow the user to search for any suitable information on the Internet or intranet for example different mobile phone forming a network with other mobile phones or other devices in a networked environment.

In one exemplary embodiment, a settings menu may be provided for the search function that allows a user to select or associate the search function with a particular search engine that may be used for searching within the mobile phone or outside the first mobile Internet device 220a (e.g. the Internet 240/intranet, etc.). In other embodiments, a default search engine may be associated with the search function during manufacture of the first mobile Internet device 220a where the default search engine 260 may or may not be changeable by the user. In alternate embodiments, the search function may allow a user to search the contents of other external or peripheral devices such as other computers, mobile phones, PDAs, memory cards and the like. The other devices may be searchable via any suitable wired or wireless communications link such as Mobile Network, Bluetooth, infrared, Wi-Fi and the like.

Next step 408 is returning a set of results of the Internet search after executing the search on the Internet search engine 260 for the search query. A search is performed based on the terms that have been selected to form the search query. In one embodiment, after the content has been selected and a search query is formed, the search is performed in the background and the user may continue to operate within the first application. For example if a user was using the application word processor to read a document which is opened on the display screen 224 and desires to perform a search relating to some of the words within the document, then by selecting the word and clicking an Internet search is performed for the search query and the list of results is returned such that the user is still in the same word processor application. This saves the tedious task of leaving the opened application, then entering the search query in an Internet search engine 260, then getting the results and then returning to the application which was opened earlier.

The search is executed on a search engine and the results are returned to the user. The results of the search are displayed on the display screen 224 of the first mobile Internet device 220a at a step 410. The results may be in the form of multiple blocks of text, hyperlinks, images, files etc. If a user wants to know the contents of the results, he needs to either understand the content by the presented text or image etc which may be an abstract of the corresponding result or user has to click and follow the hyperlink to go to the webpage or file to read its contents. If the user gets the information which he seeks, he then ends the search and comes back to the first application to perform the task he was performing before initiating the search. If the user is not satisfied with the results he can modify the search query by adding another keyword which will get him more relevant results. This process continues till he gets satisfying results.

In another exemplary embodiment, the user may choose to display the search results either into the same display window on the display screen 224 from where he initiated the search or in a new window on the display screen 224. In one embodiment the results are shown in a pop-up window. In one embodiment the user may also be capable of manipulating the results. Manipulating the search results includes, but is not limited to, copying at least a portion of the search results, pasting at least a portion of the search results, deleting at least a portion the search results, saving at least a portion of the results, launching a subsequent search from the results, using the search results in accordance with user-defined rules or procedures.

In one embodiment the method 400 further includes a step of selecting the number of results to be displayed on the display screen 224. When the search is performed the results obtained may be in hundreds or even thousands, however the search engines are designed to present the most relevant results on the front page of the search results. The user may choose to show only a number say ten search results on the display screen 224.

In another exemplary embodiment, the user may specify the number of results shown on one page and to go to next pages by a click if he wants to see more results. In this way if the user does not get the required information from the results of first page can look the results of next pages.

In one embodiment, the steps 402, 404, 406, 408 and 410 of the methods 400 are performed in a single click on the content. The content is selected and when clicked the steps of the method 400 are performed in the background and the results are displayed to the user in the same display screen 224 without having the user to leave the application from where he initiated the search.

The present invention links the mobile phone's data communications functionality with the display functionality, text or image select functionality, the device's search functionality, and the Internet browser launching functionality. The selected word, phrase, text, or an image when clicked, launches the Internet search and the results are displayed in a smaller sub window in the display or in a new screen or window on the first mobile Internet device 220a.

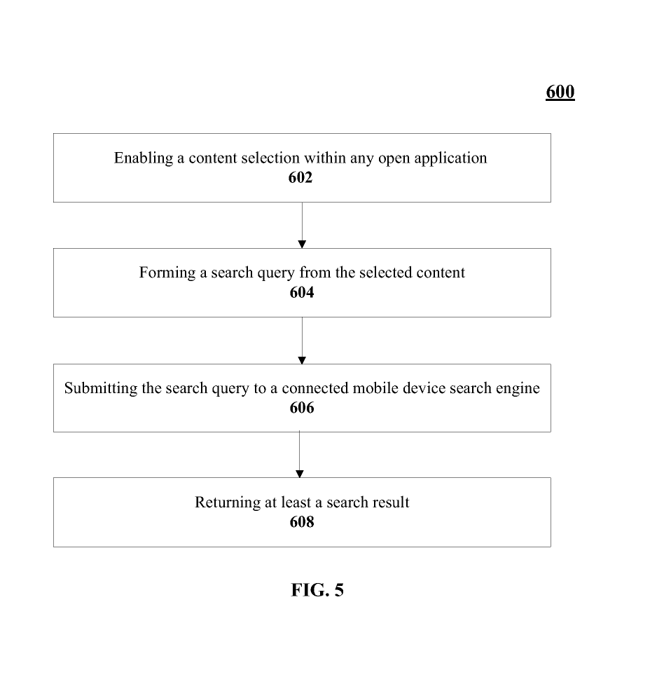

Referring to FIG. 5 which illustrates a flowchart of a method 600 for executing a dynamic search on at least contents of a connected mobile Internet device 220b from a first mobile Internet device 220a, according to an exemplary embodiment of the present invention. The method 600 comprises the steps of: enabling a content selection within any open application as displayed on a display screen of the first mobile Internet device 220a at a step 602; forming a search query from the selected content at a step 604; submitting the search query to a search engine of the second mobile Internet device 220b which is communicable connected with the first mobile Internet device 220a to perform the content search; and returning at least a search result after executing the search on the contents of the second mobile Internet device 220b and program code for displaying the set of results on the display screen 224 of the first mobile Internet device 220a.

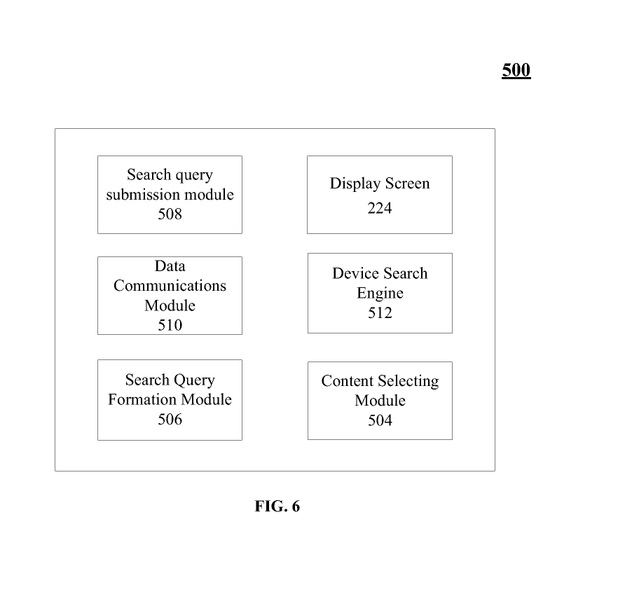

Referring to FIG. 6 which illustrates a schematic diagram of system 500 for dynamic content search on a first mobile Internet device 220a, according to an exemplary embodiment of the present invention. The system 500 comprises: a display screen 224 of the first mobile Internet device 220a; a content selecting module 504 for selecting a content within any open application as displayed on the display screen 224 of the first mobile Internet device 220a; a search query formation module 506 to form a search query from the selected content; at least a device search engine 512 configured executing the search; a search query submission module 508 for submitting the search query to at least one of an Internet search engine 260 and the device search engine 512; and a data communications module 510. All these elements of the system 500 may be implemented as software in at least one the first mobile Internet device 220a and the connected mobile Internet device 222.

The content in the form of text or image is displayed on the display screen 224. The display screen 224 displays the contents of any application opened on the first mobile Internet device 220a. The content in the form of text or image may be selected by the content selecting module 504 and a search query is formed from the selected content using the search query formation module 506. The search query submission module 508 submits the search query to at least one of the Internet search engine 260 and the device search engine 512 for executing the search. The data communications module 510 allows different components of the system 500 to communicate and exchange data with each other and with outside network such as Internet 240 or the device content. The search is conducted based on the search query and the results are returned and displayed on the display screen 224. The system 500 provides Internet search functionality by one click. It combines the functionality of all components and launches the Internet search function and administers the display of the results onto the existing window of the display screen 224 or in a new window of the display screen 224.

This invention introduces a new display driver Internet search function that links multiple applications of the operating system of the first mobile Internet device 220a. In one embodiment the system 500 is developed integrated in the operating system of the first mobile Internet device 220a. In another embodiment the system 500 may be developed as a new software component in the form of a downloadable application for the first mobile Internet device 220a. The system 500 performs the Internet search function and provides the user an option to select any screen displayed text or image and launch an Internet search or the device content search. The display driver search controller also provides the user an option to select the search browser and the received content display options.

The system 500 connects data connectivity, text or image selection functionality, search launch functionality, and the results rendering functionality together to make this invention work. Based on the user selected text or image, the system 500 launches the Internet 240 or device content search function and administers the display of the results onto the existing display screen 224 or in a new display screen. The system 500 may also provide the user with the option to select the search engine, where to search (web or the device content), and the returned search results display options.

The user can specify which terms are to be searched. The user is also able to specify how the search is to be performed, whether it is a context based search or strictly limited to the terms or words that have been selected by the user. The user is able to indicate how the search is to be performed and where the search is to be performed. The user is also able to indicate how many results are to be returned.

In an exemplary embodiment, the present invention provides a computer program product having computer executable instructions stored in a computer readable medium for directing a computer embodied in a first mobile Internet device 220a. The computer program product comprising at least a program code for executing at least one of the steps of: enabling a content selection within any open application as displayed on a display screen 224 of the first mobile Internet device 220a; forming a search query from the selected content; submitting the search query to a search engine to perform the search; returning at least a search result after executing the search on the search engine for the search query; and displaying the search result on the display screen 224 of the first mobile internet device 220a.

In an embodiment, the search engine is Internet search engine and the search is performed on the World Wide Web.

In another embodiment, the search engine is the first mobile Internet device search engine and the search is performed on the content of first mobile Internet device 220a.

In another embodiment, the search engine is the first mobile Internet device search engine and the search is performed on the content of the second mobile Internet device 220b.

In an exemplary embodiment, the present invention provides a computer program product comprising computer executable instructions stored in a computer readable medium for directing a computer embodied in a first mobile Internet device 220a for executing dynamic search on the content of the first mobile Internet device 220a. The computer program product comprising at least a program code for executing at least one of the steps of: enabling the selection of a content within any open application as displayed on a display screen 224 of the first mobile Internet device 220a; forming a search query from the selected content; submitting the search query to a search engine of the first mobile Internet device 220a to perform the content search; returning at least a search result after executing the search on the content of the first mobile Internet device 220a; and displaying the set of results on the display screen 224 of the first mobile Internet device 220a.

In an exemplary embodiment, the present invention provides a computer program product comprising computer executable instructions stored in a computer readable medium for directing a computer embodied in a first mobile Internet device 220a for executing dynamic search on the content of a second mobile Internet device 220b which is communicably connected with the first mobile Internet device 220a. The computer program product comprising at least a program code for executing at least one of the steps of: enabling a content selection within any open application as displayed on a display screen of the first mobile Internet device 220a; forming a search query from the selected content; submitting the search query to a search engine of a second mobile Internet device to perform the content search; returning at least a search result after executing the search on the content of the second mobile Internet device 220b and program code for displaying the set of results on the display screen 224 of the first mobile Internet device 220a.

The present invention relieves a user from leaving an application to externally and manually execute a search. The results of the search can be stored, incorporated into the specific application, viewed, pre-viewed or otherwise handled as specified by a user.

The disclosed embodiments may also include software and computer programs incorporating the steps of methods 400 and 600 and instructions described herein that are executed in different computers.

In application, the systems 200 and 500 or methods 400 and 600 of the present invention may interface with existing applications or operating system of the first and second mobile Internet devices 220a and 220b in many ways. For example in the case of existing mobile phones, the systems 200 and 500 may be built as a downloadable app (application) for mobile phones to provide the user activated search functionality. The app may be developed, using open application interfaces of the mobile phone operating system (e.g. Android), such that it links the existing display driver, Internet connection function, search function, and content rendering function to provide the dynamic search function on mobile Internet devices/phones according to the present invention. This new application once downloaded in the first mobile Internet device 220a will allow the user to perform Internet 240 or device content search for text or image by simple selection of the object and requesting the search.

In case of new mobile devices this enhanced search functionality may be integrated with operating system of the mobile devices. In this embodiment, within the kernel of the mobile operating system (e.g. Windows Mobile 7), develop a display Internet search controller that links the display driver, Internet connection function, Internet search function, device content search function, and content rendering function. This new mobile device operating system can power the new mobile devices which will allow the user to perform internet or device content search for text or image by simple selection the object on the display screen 224 and request the search. This invention may get embedded in other internet appliances with mobile communications functionality. Also, this internet search functionality may get linked to the find functionality for the internal content in at least the first mobile Internet device 220a.

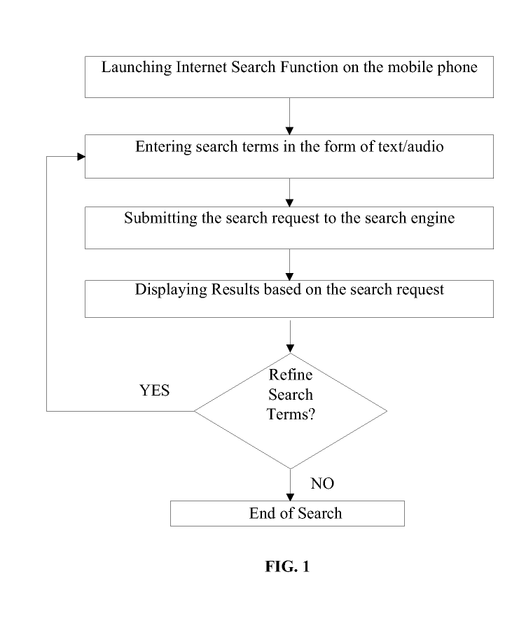

In various exemplary embodiments of the present invention, the operations discussed herein, e.g., with reference to FIGS. 1 to 6, may be implemented through computing devices such as hardware, software, firmware, or combinations thereof, which may be provided as a computer program product, e.g., including a machine-readable or computer-readable medium having stored thereon instructions or software procedures used to program a computer to perform a process discussed herein. The machine-readable medium may include a storage device. For example, the operation of components of the systems 200 and 500 and method 400 may be controlled by such machine-readable medium.

In other instances, well-known methods, procedures, components, and circuits have not been described herein so as not to obscure the particular embodiments of the present invention. Further, various aspects of embodiments of the present invention may be performed using various means, such as integrated semiconductor circuits, computer-readable instructions organized into one or more programs, or some combination of hardware and software.

Although a particular exemplary embodiment of the invention has been disclosed in detail for illustrative purposes, it will be recognized to those skilled in the art that variations or modifications of the disclosed invention, including the rearrangement in the configurations of the parts, changes in sizes and dimensions, variances in terms of shape may be possible. Accordingly, the invention is intended to embrace all such alternatives, modifications and variations as may fall within the spirit and scope of the present invention.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is understood that various omissions, substitutions of equivalents are contemplated as circumstance may suggest or render expedient, but is intended to cover the application or implementation without departing from the spirit or scope of the claims of the present invention.

I claim:

1. A method for executing dynamic content search on a first mobile Internet device, comprising the steps of:
enabling a content selection for search within any open application as displayed on a display screen of the first mobile Internet device;
forming a search query from the selected content;
submitting the search query to at least a search engine to perform the search;
receiving a set of results of the search after executing the search on the search engine for the search query; and
displaying the set of results on the display screen of the first mobile Internet device.

2. The method according to claim 1, wherein the search engine is Internet search engine and the search is performed on the World Wide Web.

3. The method according to claim 1, wherein the search engine is the first mobile Internet device search engine and the search is performed on at least a content of the first mobile Internet device.

4. The method according to claim 1, wherein the search engine is the first mobile Internet device search engine and the search is performed on content of a second mobile Internet device which is communicably connected with the first mobile Internet device.

5. The method according to claim 1, wherein the content includes at least one from a group including a word, a phrase, an image, an object on the display screen of the first mobile Internet device or any combination thereof.

6. The method according to claim 1, wherein the step of enabling the content selection is done by at least one action from a group including clicking on the content, touching on the content, pressing a button on the first mobile Internet device, a voice command or any combination thereof.

7. The method according to claim 1, further comprises a step of enabling the Internet search engine selection to perform the Internet search.

8. The method according to claim 7, wherein the step of enabling the Internet search engine selection includes selection of a plurality of search engines simultaneously.

7. The method according to claim 1, wherein the step of submitting of the search query to the first mobile Internet device search engine is done by providing a link dynamically formed by combining the search query and the search engine, such that the link is activated by a click.

8. The method according to claim 1, further comprising a step of providing a choice to display the set of results on an opened window on the display screen or on a new window on the display screen.

9. The method according to claim 1, wherein the set of results are capable of being stored, incorporated into a specific application on the first mobile Internet device, viewed, pre-viewed, or handled as specified by a user.

10. The method according to claim 1, further comprising a step of selecting a number of results to be displayed on the display screen.

11. A method for executing a dynamic search on at least content of a connected mobile device, comprising the steps of:
enabling a content selection within any open application as displayed on a display screen of the first mobile Internet device;
forming a search query from the selected content;
submitting the search query to a search engine of a second mobile Internet device to perform the content search;
returning at least a search result after executing the search on the content of the second mobile Internet device and program code for displaying the set of results on the display screen of the first mobile Internet device.

14. A system for dynamic Internet search on a mobile Internet device, comprising:
a content selecting module configured for selecting a content within any open application as displayed on a display screen of the mobile Internet device;
a search query formation module configured to form a search query from the selected content;
a search query submission module configured for submitting the search query to an Internet search engine; and
a data communications module configured to communicate the data related to the search query,
wherein a search engine selection module is adapted to select at least one of the Internet search engine and mobile device search engine.

15. The system according to claim 14, wherein the data communication module is capable of enabling different components of the system to communicate and exchange data with each other and with an outside network including the Internet.

16. The system according to claim 14, wherein the system is integrated with an operating system of the mobile Internet device.

17. The system according to claim 14, wherein the system is a downloadable application for the mobile Internet device.

18. A computer program product having computer executable instructions stored in a computer readable medium for directing a computer embodied in a first mobile Internet device, the computer program product comprising at least a program code for executing at least one of the steps of:
enabling a content selection within any open application as displayed on a display screen of the first mobile Internet device;
forming a search query from the selected content;
submitting the search query to a search engine to perform the search;
returning at least a search result after executing the search on the search engine for the search query; and
displaying the search result on the display screen of the first mobile Internet device.

19. A computer program product comprising computer executable instructions stored in a computer readable medium for directing a computer embodied in a first mobile Internet device for executing dynamic search on the content of the first mobile Internet device, the computer program product comprising at least a program code for executing at least one of the steps of:
enabling the selection of a content within any open application as displayed on a display screen of the first mobile Internet device;
forming a search query from the selected content;
submitting the search query to a search engine of the first mobile Internet device to perform the content search;
returning at least a search result after executing the search on the content of the first mobile Internet device; and
displaying the search result on the display screen of the first mobile Internet device.

20. A computer program product comprising computer executable instructions stored in a computer readable medium for directing a computer embodied in a first mobile Internet device for executing dynamic search on at least a content of a second mobile Internet device, the computer program product comprising at least a program code for executing at least one of the steps of:
enabling a content selection within any open application as displayed on a display screen of the first mobile Internet device;
forming a search query from the selected content;
submitting the search query to a search engine of the second mobile Internet device to perform the content search; and
returning at least search result after executing the search on the content of the second mobile Internet device and program code for displaying the set of results on the display screen of the first mobile Internet device.
